(19) United States
(12) Patent Application Publication
(10) Pub. No.: US 2001/0023022 A1
(43) Pub. Date: Sep. 20, 2001

(54) Group III-V compound semiconductor wafers and manufacturing method thereof

(76) Inventors: Takayuki Nishiura, Itami-shi (JP); Hideki Miyajima, Itami-shi (JP)

Correspondence Address: FASSE PATENT ATTORNEYS, P.A., P.O. BOX 726, HAMPDEN, ME, 04444-0726, US

(21) Appl. No.: 09/780,872

(22) Filed: Feb. 8, 2001

(30) Foreign Application Priority Data
Feb. 10, 2000 (JP) 2000-033777(P)

(51) Int. Cl. B32B 9/00

(52) U.S. Cl. 428/409; 117/954

(57) ABSTRACT

A high quality Group III-V compound semiconductor wafer is provided which is free from precipitation of a Group V element on its surface. In the group III-V compound semiconductor wafer of the present invention, the number of acid material atoms per 1 cm² is at most 5×10¹².

### BACKGROUND OF THE INVENTION

1. Field of the Invention

The present invention relates to compound semiconductor wafers in Group III-V of a periodic table used for semiconductor integrated circuit devices or the like, and more specifically to a semiconductor wafer of a compound such as gallium-arsenide compound (GaAs) and a manufacturing method thereof.

2. Description of the Background Art

Conventionally, semiconductor wafers of a Group III-V compound such as GaAs are used for devices of FETs (Field Effect Transistors), semiconductor lasers and the like. In manufacturing a Group III-V compound semiconductor wafer, an ingot of a Group III-V compound semiconductor is manufactured. Then, the ingot is sliced into plates, on which finishing processes such as etching and lapping are performed to provide wafers. Then, the surface of the wafer is polished with use of a polishing solution, which will be washed away. Thereafter, alkali cleaning is performed. Finally, an epitaxial layer is formed on the surface of the wafer.

As stated above, since the epitaxial layer is formed on the surface of the wafer, a significant surface roughness of the wafer results in crystal defects in the epitaxial layer formed thereon. The crystal defects in the epitaxial layer of the wafer leads defective FETs or the like. As a result, the product yield decreases. To prevent the yield decrease, the surface roughness of the wafer is desirably minimized.

However, conventionally, a gallium-arsenide compound semiconductor wafer suffers from a surface cloudiness caused by precipitation of fine arsenic particles on the wafer surface. The wafer with a cloudy surface generally has a significant surface roughness and, if an epitaxial layer is formed thereon, crystal defects are caused in the epitaxial layer and the FET yield decreases.

Exemplary methods of preventing precipitation of arsenide as described above include a method of acid-treating a wafer surface in the dark as disclosed in Japanese Patent Laying-Open No. 11-219924. However, this method also suffers from the problem of precipitation of arsenide on the wafer surface, and therefore it is difficult to minimize the surface roughness.

### SUMMARY OF THE INVENTION

Therefore, the present invention is made to solve the aforementioned problem. An object of the present invention is to provide a Group III-V compound semiconductor wafer with reduced surface roughness and higher yield if processed into an FET or the like, as well as a manufacturing method thereof.

The present inventors have studied a mechanism by which a Group V element, e.g., arsenic, precipitates on the wafer surface of a Group III-V compound semiconductor wafer. The study has found that precipitation of the Group V element occurs when a concentration of an acid material is high at the wafer surface. Note that, in the present specification, a term “acid material” refers to a material which reacts with or dissolves in water to exhibit acidity, such as halogen including chlorine, fluoride, bromine, or iodine, nitrogen oxide (NOₓ), sulfur oxide (SOₓ), and hydrogen chloride.

In a process of manufacturing a Group III-V compound semiconductor wafer, a highly volatile acid material such as hydrochloric acid or nitric acid is used. For polishing a gallium-arsenide compound semiconductor wafer, a polishing solution including colloidal silica is used. The polishing solution contains a significant amount of chlorine, i.e., an acid material. The step using these acid materials is generally performed at a exhaust system in a clean room. Then, the exhaust system may fail to evacuate all the acid material, whereby the acid material partially leaks out to a clean room ambient.

The Group III-V compound semiconductor wafer is polished and then cleaned for subsequent surface inspection. The surface inspection is conducted in a clean room, through which the Group III-V compound semiconductor wafer is exposed to the clean room ambient for at least one hour. Meanwhile, a small amount of flowing acid material, resulting from the above mentioned polishing step or the like, adheres to the surface of the Group III-V compound semiconductor wafer. The acid material reacts with a Group V element forming the Group III-V compound semiconductor wafer, whereby the Group V element precipitates. Thus, to prevent precipitation of the Group V element, the concentration of the acid material at the wafer surface of the Group III-V compound semiconductor must be decreased.

In view of the above, the Group III-V compound semiconductor wafer of the present invention is the number of acid material atoms per 1 cm² is at most 5×10¹² at its surface. Note that the number of acid material atoms refers to the number of halogen atoms in the case of halogen such as fluoride, chlorine, bromine, or iodine. In the case of a compound such as nitrogen oxide (NOₓ), or sulfur oxide (SOₓ), it refers to the number of molecules in the compound.

The Group III-V compound semiconductor wafer thus structured has less number of acid material atoms at its surface, whereby precipitation of the Group V element can be prevented. As a result, the Group III-V compound semiconductor wafer has reduced surface roughness and, even if such wafers are processed into FETs or the like, the yield would not decrease.

Preferably, the Group III-V compound semiconductor wafer is formed of a gallium-arsenide compound. In this case, in particular, precipitation of arsenic is prevented.

A method of manufacturing a Group III-V compound semiconductor wafer of the present invention includes the steps of preparing a Group III-V compound semiconductor wafer, and processing the Group III-V compound semiconductor wafer to limit the number of acid material atoms per 1 cm² to at most 5×10¹² at the surface of the Group III-V compound semiconductor wafer.

According to the manufacturing method, less number of acid material atoms are maintained at the surface of the Group III-V compound semiconductor wafer, whereby precipitation of the Group V element at the surface can be prevented. As a result, the Group III-V compound semiconductor wafer has reduced surface roughness and, if such wafers are processed into FETs or the like, the yield would not decrease.

Preferably, the Group III-V compound semiconductor wafer is formed of a gallium-arsenide compound. In this case, precipitation of arsenic can be prevented.

More preferably, the step of processing the Group III-V compound semiconductor wafer is performed in an ambient with a concentration of acid material limited to at most 0.02 weight ppm. Note that “ppm” refers to weight parts per million throughout the description. In this case, by controlling the concentration of acid material in the ambient for manufacturing the Group III-V compound semiconductor wafer, the concentration of acid material at the surface of the Group III-V compound semiconductor wafer can be controlled.

More preferably, the step of processing the Group III-V compound semiconductor wafer includes a step of polishing the surface of the Group III-V compound semiconductor wafer, and a step of cleaning the polished Group III-V compound semiconductor wafer, and an adsorbent is provided in the ambient for the polishing and cleaning steps in order to eliminate the acid material. In this case, the acid material is eliminated by the adsorbent, so that the acid material can be reliably reduced.

Preferably, the acid material is chlorine and the adsorbent is active carbon. In this case, the chlorine well adheres to be active carbon, whereby the acid material can be eliminated more effectively.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a surface condition of a sample 15.

FIG. 2 is a diagram showing in enlargement a portion enclosed by a dotted line II in FIG. 1.

FIG. 3 is a diagram showing in enlargement a portion enclosed by a dotted line III in FIG. 1.

### DESCRIPTION OF THE PREFERRED EMBODIMENTS

Now, the embodiments of the present invention will be described.

First Embodiment

In the first embodiment, in a process of manufacturing a Group III-V compound semiconductor wafer, active carbon for adsorbing chlorine, i.e., acid material, was provided in a circulation system of an air conditioner in a clean room, so as to maintain the concentration of acid material in the clean room, specifically the chlorine atoms, at 0.02 weight ppm. In the clean room, acid materials such as polishing solution, aqua regia and chlorine are generally used, and most of the acid material would be evacuated by the exhaust system. The part of the acid material, not evacuated by the exhaust system, is absorbed to the active carbon in the circulation system. Thus, even if the active material volatilizes in the clean room ambient, the active carbon can well adsorbs them.

In such a clean room, the concentration of acid material atoms (chlorine atoms) was maintained at 0.01 ppm in an ambient of manufacturing a gallium-arsenide compound semiconductor wafer as the Group III-V compound semiconductor wafer. In this ambient, etching and lapping were performed on the surface of the gallium-arsenide compound semiconductor wafer, and thereafter, the wafer surface was polished by an INSEC polishing solution produced by Fujumi Incorporated. Still in the same ambient, the polished wafer was cleaned by D.I.Water (Deionized Water) and then alkalic cleaning was performed to produce a sample 1.

Then, the amount of active carbon in the circulation system was reduced to maintain the concentration of acid material atoms (chlorine atoms) at 0.06 weight ppm in the ambient of manufacturing the gallium-arsenide compound semiconductor wafer as the Group III-V compound semiconductor wafer. In this ambient, etching and lapping were performed on the surface of the gallium-arsenide compound semiconductor wafer, and the same polishing solution as for sample 1 was used to polish the wafer surface. Thereafter, the surface of the wafer was cleaned by D.I.Water and alkali cleaning was performed to produce a sample 2.

For samples 1 and 2, the number of acid material atoms (chlorine atoms) per 1 cm² was determined at the surface of samples 1 and 2 with use of a TXRF (Total X-ray Reflection Flourescence).

Sample 1 was allowed to stay for one hour in an ambient where the concentration of chlorine atoms was 0.01 weight ppm. Further, sample 2 was allowed to stay for one hour in an ambient where the concentration of the chlorine atom was 0.06 weight ppm. For these samples 1 and 2, the wafer surface was inspected for cloudiness. For cloudiness inspection, SURFSCAN4500 produced by Tencor Corporation was used. This apparatus scans the surface of the gallium-arsenide compound semiconductor wafer by a laser light and collects scattered light. Based on an intensity of the collected light or the like, the size of the particle precipitated on the wafer surface was measured. If the size of the particle exceeds a prescribed value, it is determined cloudy. The result is shown in the following Table 1.

TABLE 1

| | Acid material (chlorine | No. (× 10¹²) of acid | Condition of |
|---|---|---|---|
| | atom) concentration in | material atoms | wafer surface |
| Sample | manufacturing ambient | (chlorine atoms) at | after elapse of |
| No. | (weight ppm) | wafer surface (/cm²) | time |
| 1 | 0.01 | 1.36 | not cloudy |
| 2 | 0.06 | 22.73 | cloudy |

In the above Table 1, “not cloudy” means that no precipitation was found on the wafer surface. “Cloudy” means that precipitation was found on the wafer surface.

From the above Table 1, sample 1 with lower concentration of acid material in the manufacturing ambient has a smaller number of acid material atoms on its wafer surface. Thus, a high quality gallium-arsenide compound semiconductor wafer was obtained free from cloudiness at the wafer surface after elapse of time. On the other hand, sample 2 has a higher concentration of the acid material in the manufacturing ambient, and hence it has a greater number of acid material atoms on the wafer surface, causing cloudiness after the elapse of time. Thus, the gallium-arsenide compound semiconductor wafer has poor quality.

It is noted that the wafer which has been polished and cleaned in accordance with the above described steps is subjected to foreign matter inspection by a surface foreign matter inspecting apparatus and surface inspection using a high-luminance illumination in a dark room. Then, it is put in a resin container such as a wafer tray manufactured by Fluoroware. It is further sealed in an aluminum laminate with an inactive gas for shipment.

Second Embodiment

In the second embodiment, in the process of manufacturing a gallium-arsenide compound semiconductor wafer as in the first embodiment, the concentration of chlorine atoms in the manufacturing ambient is varied, so that samples 11 to 16 of the gallium-arsenide compound semiconductor wafers with varying number of acid material atoms (chlorine atoms) at the wafer surface (1 cm²) were manufactured. Each of these samples was allowed to stay for one hour in an ambient of manufacturing that sample for subsequent cloudiness inspection of the wafer surface. For cloudiness inspection, SURFSCAN4500 manufactured by Tencor was used as in the first embodiment. The result is shown in the following Table 2.

TABLE 2

| | No. (× 10¹²) of acid material | Condition of wafer |
|---|---|---|
| Sample | atoms (chlorine atoms) at wafer | surface after elapse |
| No. | surface (/cm²) | of time |
| 11 | 0.58 | not cloudy |
| 12 | 2.51 | not cloudy |
| 13 | 5.77 | little cloudy |
| 14 | 13.04 | cloudy |
| 15 | 36.43 | extremely cloudy |
| 16 | 32.48 | extremely cloudy |

In the above Table 2, in the column showing wafer surface condition, “not cloudy” means that no precipitation was found on the wafer surface. “Little cloudy” means that precipitation was found over a portion corresponding to at most 10% of the wafer surface. “Cloudy” means that precipitation was found at least 10% and at most 30% of the wafer surface. “Extremely cloudy” means that precipitation was found over a portion exceeding 30% of the wafer surface. From Table 2, it is seen that samples 11 and 12 with less number of acid material atoms (chlorine atoms) on the wafer surface are free from cloudiness, providing high-quality gallium-arsenide compound semiconductor wafers. Samples 13 and 14 have greater number of acid material atoms on the wafer surface as compared with samples 11 and 12, thus having cloudy wafers surfaces. Samples 15 and 16 have particularly greater number of acid material atoms on the wafer surface, and thus having extremely cloudy wafer surface.

From the above, it is seen that the number of acid material atoms (chlorine atoms) per 1 cm² is preferably at most 5×10¹².

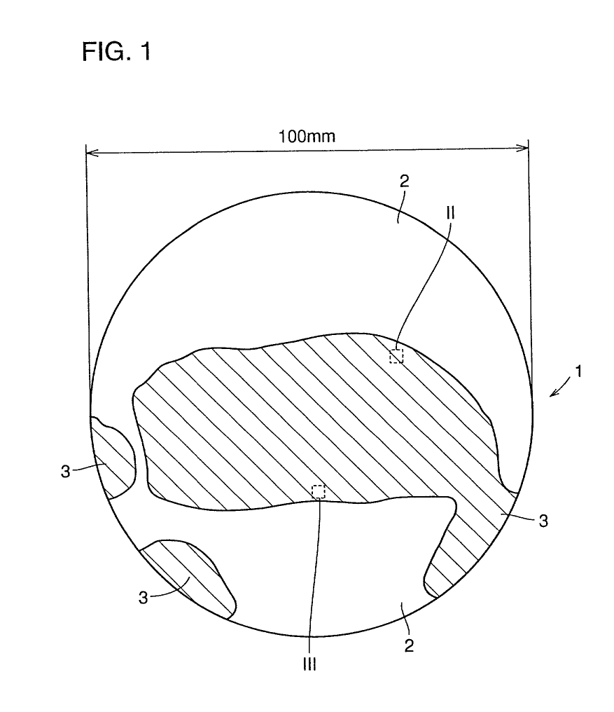

For Sample 15, the surface condition was observed by an optical microscope. The result is shown in FIG. 1.

Referring to FIG. 1, a gallium-arsenide compound semiconductor wafer 1 has a clear region 2 and a cloudy region 3 at its surface. Gallium-arsenide compound semiconductor wafer 1 has cloudy region 3 which occupies approximately half the entire surface. Note that gallium-arsenide compound semiconductor wafer 1 has a diameter of 100 mm.

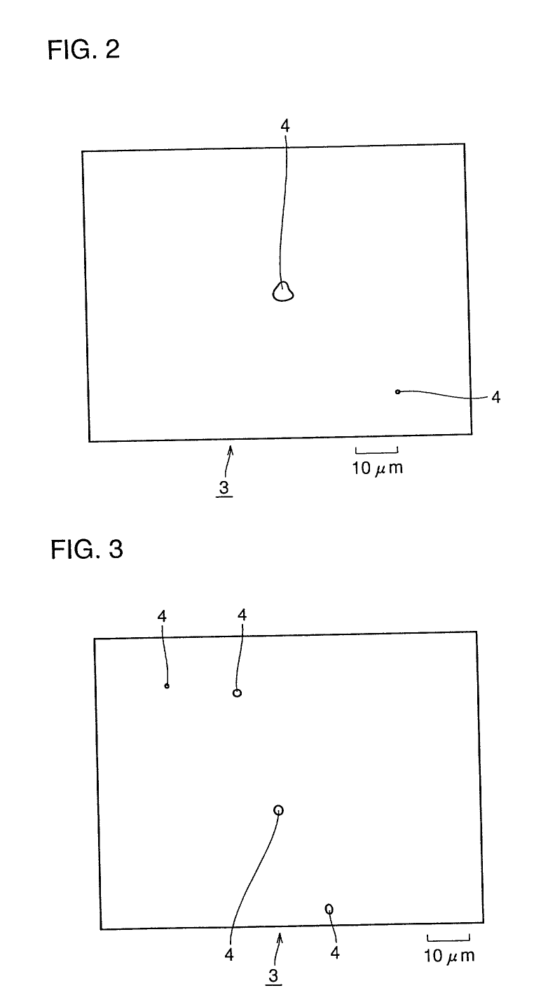

Referring to FIGS. 2 and 3, a small amount of arsenide precipitation 4 was found in cloudy region 3. Precipitation 4 is found in a spot-like manner, most of which have a size of 10 μm or smaller.

Although the embodiments of the present invention has been described in the above, the embodiments herein disclosed may be subjected to various modifications. For example, as a Group III-V compound semiconductor substrate, not only the above described gallium-arsenide compound semiconductor wafer but also an indium-phosphide compound semiconductor wafer or aluminum-gallium-arsenide compound semiconductor wafer may be used.

Under the manufacturing condition with lower concentration of chlorine atoms, by controlling the atom number of halogen as an acid material such as fluoride, bromine, or iodine, as well as nitrogen oxide (NOₓ), sulfur oxide (SOₓ) and hydrogen chloride (HCl) not to exceed 5×10¹², an effect similar to the present invention can be produced.

According to the present invention, a Group III-V compound semiconductor wafer free from cloudiness at its surface and still providing high yield when processed into FETs or the like in the following process.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A Group III-V compound semiconductor wafer comprising a surface, said surface including at most 5×10¹² atoms of an acid material per 1 cm².

2. The Group III-V compound semiconductor wafer according to claim 1, wherein said Group III-V compound semiconductor wafer includes a gallium-arsenide compound.

3. A method of manufacturing a Group III-V compound semiconductor wafer, comprising the steps of:
preparing a Group III-V compound semiconductor wafer, and
processing said Group III-V compound semiconductor wafer to limit a number of acid material atoms per 1 cm² to at most 5×10¹² at a surface of said Group III-V compound semiconductor wafer.

4. The method of manufacturing the Group III-V compound semiconductor wafer according to claim 3, wherein said Group III-V compound semiconductor wafer includes a gallium-arsenide compound.

5. The method of manufacturing the Group Ill-V compound semiconductor wafer according to claim 3, wherein said step of processing the Group III-V compound semiconductor wafer is performed in an ambient with a concentration of an acid material limited to at most 0.02 weight ppm.

6. The method of manufacturing the Group III-V compound semiconductor wafer according to claim 4, wherein said step of processing the Group III-V compound semiconductor wafer is performed in an ambient with a concentration of an acid material limited to at most 0.02 weight ppm.

7. The method of manufacturing the Group III-V compound semiconductor wafer according to claim 5, wherein said step of processing the Group III-V compound semiconductor wafer includes the steps of polishing a surface of said Group III-V compound semiconductor wafer and cleaning said polished Group III-V compound semiconductor wafer, and an adsorbent for eliminating said acid material is supplied in an ambient for said polishing and cleaning steps.

8. The method of manufacturing the Group III-V compound semiconductor wafer according to claim 7, wherein said acid material is chlorine and said adsorbent is active carbon.
